(19) United States
(12) Patent Application Publication
(10) Pub. No.: US 2007/0283329 A1
(43) Pub. Date: Dec. 6, 2007

(54) System and method for performance monitoring and diagnosis of information technology system

(75) Inventors: Gaurav Caprihan, Bangalore (IN); Ram Kumar, Bangalore (IN); Surendra Babu Bysani, Bangalore (IN); Nikhil Venugopal, Secunderabad (IN)

Correspondence Address: NIXON PEABODY, LLP, 401 9TH STREET, NW, SUITE 900, WASHINGTON, DC, 20004-2128, US

(73) Assignee: INFOSYS TECHNOLOGIES, LTD., Bangalore (IN)

(21) Appl. No.: 11/650,560

(22) Filed: Jan. 9, 2007

(30) Foreign Application Priority Data
Jan. 9, 2006 (IN) 40/CHE/2006

(51) Int. Cl. G06F 9/44

(52) U.S. Cl. 717/127

(57) ABSTRACT

A system, method and computer program product for performance monitoring and diagnosis of a target machine, including installing a management console configured to communicate with an agent deployed on a target machine; gathering performance data of the target machine via the agent deployed on a target machine; sending via the agent deployed on a target machine the gathered performance data of the target machine to the management console at regular intervals for diagnosis; diagnosing the performance data captured at the regular intervals using a knowledge base representation technique via a diagnosis engine; and raising an alert event on the target machine depending on a criticality of the diagnosed performance data via the diagnosis engine.

### CROSS REFERENCE TO RELATED DOCUMENTS

This application claims priority under 35 U.S.C. §119 to Indian Patent Application Serial No. 40/CHE/2006 of CAPRIHAN et al., entitled “SYSTEM AND METHOD FOR PERFORMANCE MONITORING AND DIAGNOSIS OF PRODUCTION ENTERPRISE SYSTEMS,” filed Jan. 9, 2006, the entire disclosure of which is hereby incorporated by reference herein.

### BACKGROUND OF THE INVENTION

1. Field of the Invention

The present invention relates generally to information technology (IT) application systems, and more particularly, to a system and method for performance monitoring and diagnosis of IT application systems.

2. Discussion of the Background

The information technology (IT) Infrastructure of an organization is its lifeline. With competition a mere click away, IT managers the world over have to deal with the double edged sword of needing to support enterprise systems with a high degree of agility and 24×7 uptime while having lesser and lesser budgets available to them. The ever increasing Business-IT alignment only adds to their woes by expanding their scope of responsibility each day. In order to ensure that systems are available and running with adequate capacity at all times, system administrators need to continuously monitor the entire stack right from the application tier down to the infrastructure on which it is hosted and take corrective measures to mitigate any potential problems ahead of time. This requires the administrators to be adept at identifying symptoms of problems from the deluge of data thrown at them by the various application monitoring tools available in the market today.

Most organizations today host heterogeneous operating environments which make it necessary to maintain a battery of dedicated and skilled personnel to support each of these applications and/or platforms. For example, as shown in FIG. 1, the architecture could include different clients 102 over a firewall 104 connecting to multiple servers 108 and databases 110 deployed over a variety of hardware and operating systems. Supporting or troubleshooting this kind of setup would require many experts.

This, however, is in direct conflict with the recent trend across enterprises to cut costs by trimming their operating staff. Therefore, there is a dire need for experts who can manage more than one application and/or technology or to adopt intelligent systems that use knowledge based reasoning to perform system management tasks.

### SUMMARY OF THE INVENTION

The above and other needs are addressed by the present invention, which in one aspect relates to a method, system, and software for performance monitoring and diagnosis of a target machine, including installing a management console configured to communicate with an agent deployed on a target machine; gathering performance data of the target machine via the agent deployed on a target machine; sending via the agent deployed on a target machine the gathered performance data of the target machine to the management console at regular intervals for diagnosis; diagnosing the performance data captured at the regular intervals using a knowledge base representation technique via a diagnosis engine; and raising an alert event on the target machine depending on a criticality of the diagnosed performance data via the diagnosis engine.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary system deployment diagram;

FIG. 2 illustrates an exemplary tool for performance monitoring and diagnosis of information technology (IT) application systems, according to an exemplary embodiment; and

FIG. 3 illustrates an exemplary process flow for performance monitoring and diagnosis of production enterprise application systems, according to an exemplary embodiment.

### DETAILED DESCRIPTION OF THE PREFERRED EMBODIMENTS

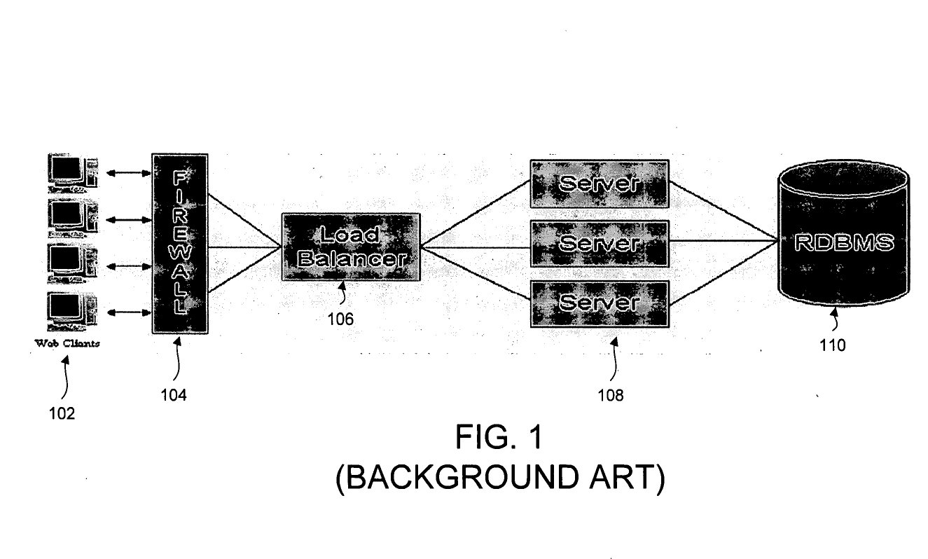

Referring now to the drawings, wherein like reference numerals designate identical or corresponding parts throughout the several views, and more particularly to FIGS. 1-3 thereof, which will be used to illustrate a method, system, and software for performance monitoring and diagnosis of information technology (IT) application systems, accordingly to exemplary embodiments.

The present invention meets the business challenges in the field of performance engineering, advantageously, overcoming the aforementioned challenge by an efficient and novel technique, including a novel approach based on a monitoring and diagnosis automation framework, accordingly to exemplary embodiments. The exemplary embodiments accomplish the task of monitoring online production heterogeneous operating environments and diagnosing them for potential performance bottlenecks by generating alerts, events, and the like, at run-time.

The exemplary embodiments include the novel features of combining the performance data captured using industry standard protocols (e.g., Simple Network Management Protocol (SNMP), Windows Management Instrumentation (WMI) or any other suitable protocol or method of data capture, and the like), with a knowledge base representation technique (e.g., acyclic graphs, and the like) that can detect performance bottlenecks at the system (e.g., infrastructure, operating system, middleware, and the like) and application layer.

In an exemplary embodiment, the novel processes, for example, include:

1. Capturing online system and application performance counters from the servers in a production environment using a protocol, such Simple Network Management Protocol, and the like, and which may also be extensible to others protocols and metrics.

2. Detecting the potential bottlenecks based on an existing set of performance heuristics represented in the form of an acyclic graph.

3. Alerting the user in case of any system level and application level bottlenecks.

4. Coming up with possible recommendations to resolve bottlenecks that are periodically noticed.

The exemplary embodiments can include a first component that deals with capturing predefined performance metrics related to system and application using industry standard protocols, and a second component that deals with diagnosis engine relying on a collection of performance heuristics. The strength of the engine lies in the knowledge base which constitutes these performance heuristics. Hence, an exemplary feature of the engine is to offer flexibility to maintain and update these heuristics over time.

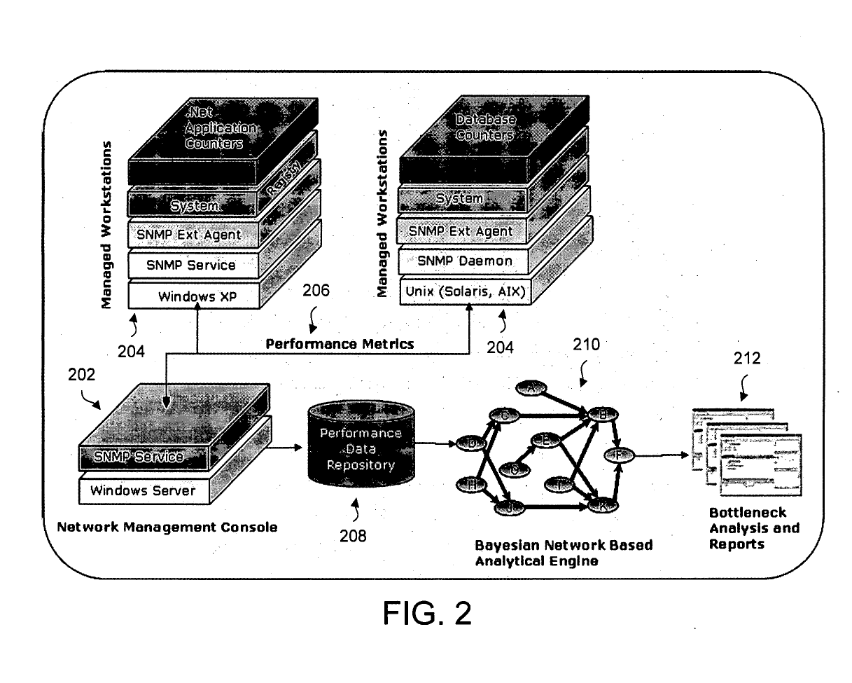

FIG. 2 illustrates an exemplary tool for performance monitoring and diagnosis of IT application systems, according to an exemplary embodiment. In FIG. 2, a centralized management console 202 sends requests to target machines 204 and captures the corresponding system, application performance data or metrics 206. The target machines 204 can include SNMP master and sub agents configured to receive the SNMP requests from the management console 202 and service the request with performance data 206. A central repository 208 is provided for the data captured from all the target machines 204. A knowledge base of performance heuristics or engine 210, for example, based on acyclic graphs, Bayesian Networks, and the like, is used to identify bottlenecks. A bottleneck analysis report or alerts 212 are generated by the engine 210.

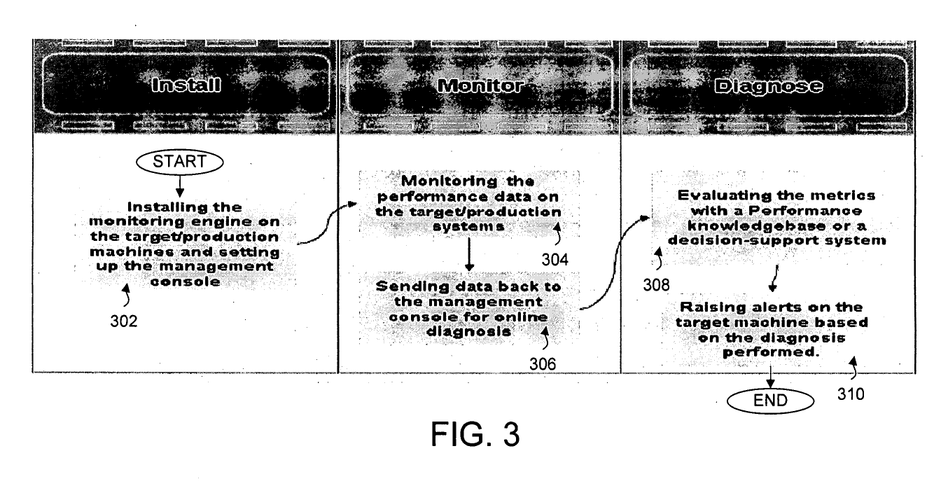

FIG. 3 illustrates an exemplary process flow for performance monitoring and diagnosis of production enterprise application systems, according to an exemplary embodiment. In FIG. 3, the exemplary process flow begins at step 302, wherein an installation phase ensures that the management console 202 has been set up and can talk to the engine agent deployed on the target machines 204. At step 304, a monitoring phase ensures that the performance data 206 is gathered on the target machine 204 and at step 306 is sent to the management console 202 at regular intervals for diagnosis. At step 308, a diagnosis phase ensures that the performance data 206 captured at regular intervals is subjected to the diagnosis engine 210 and alert events 212 are raised depending on the criticality, completing the exemplary process flow.

The exemplary embodiments can provide various features and advantages over conventional systems and methods. With respect to a business perspective, the exemplary embodiments can be used with many environments and the approach caters to the complex issue of performance monitoring and diagnosis over a heterogeneous environment making it beneficial to domains which need performance issues to be resolved. In addition, the exemplary embodiments provide improved, effective manageability of a system under consideration by automating the monitoring and diagnosing activity for online production systems. With respect to a technical perspective, the exemplary embodiments integrate a powerful monitoring activity with a powerful diagnosis activity.

The exemplary embodiments thus provide advantages, for example, including (i) a highly extensible automated system for application performance capture, (ii) performance bottleneck assessment in a crucial area of performance engineering and one that requires most expertise in terms of domain knowledge, (iii) in person independency that assures a scalable execution model and is unique in deskilling the task of automation by removing expert dependency, (iv) extension to other phases and applications, such performance testing, as well integration with other third party load testing tools for offline bottleneck analysis, and the like.

The above-described devices and subsystems of the exemplary embodiments of FIGS. 1-3 can include, for example, any suitable servers, workstations, PCs, laptop computers, PDAs, Internet appliances, handheld devices, cellular telephones, wireless devices, other devices, and the like, capable of performing the processes of the exemplary embodiments of FIGS. 1-3. The devices and subsystems of the exemplary embodiments of FIGS. 1-3 can communicate with each other using any suitable protocol and can be implemented using one or more programmed computer systems or devices.

One or more interface mechanisms can be used with the exemplary embodiments of FIGS. 1-3, including, for example, Internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the Internet, intranets, a combination thereof, and the like.

It is to be understood that the devices and subsystems of the exemplary embodiments of FIGS. 1-3 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 1-3 can be implemented via one or more programmed computer systems or devices.

To implement such variations as well as other variations, a single computer system can be programmed to perform the special purpose functions of one or more of the devices and subsystems of the exemplary embodiments of FIGS. 1-3. On the other hand, two or more programmed computer systems or devices can be substituted for any one of the devices and subsystems of the exemplary embodiments of FIGS. 1-3. Accordingly, principles and advantages of distributed processing, such as redundancy, replication, and the like, also can be implemented, as desired, to increase the robustness and performance the devices and subsystems of the exemplary embodiments of FIGS. 1-3.

The devices and subsystems of the exemplary embodiments of FIGS. 1-3 can store information relating to various processes described herein. This information can be stored in one or more memories, such as a hard disk, optical disk, magneto-optical disk, RAM, and the like, of the devices and subsystems of the exemplary embodiments of FIGS. 1-3. One or more databases of the devices and subsystems of the exemplary embodiments of FIGS. 1-3 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-3 can include appropriate data structures for storing data collected and/or generated by the processes of the devices and subsystems of the exemplary embodiments of FIGS. 1-3 in one or more databases thereof.

All or a portion of the devices and subsystems of the exemplary embodiments of FIGS. 1-3 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 1-3 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-3, for driving the devices and subsystems of the exemplary embodiments of FIGS. 1-3, for enabling the devices and subsystems of the exemplary embodiments of FIGS. 1-3 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 1-3. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-3 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of exemplary embodiments and implementations, the present invention is not so limited, but rather covers various modifications and equivalent arrangements, which fall within the purview of the appended claims.

What we claim is:

1. A method for performance monitoring and diagnosis of a target machine, the method comprising:
installing a management console configured to communicate with an agent deployed on a target machine;
gathering performance data of the target machine via the agent deployed on a target machine;
sending via the agent deployed on a target machine the gathered performance data of the target machine to the management console at regular intervals for diagnosis;
diagnosing the performance data captured at the regular intervals using a knowledge base representation technique via a diagnosis engine; and
raising an alert event on the target machine depending on a criticality of the diagnosed performance data via the diagnosis engine.

2. The method of claim 1, further comprising storing the performance data captured at the regular intervals in a database.

3. The method of claim 1, wherein the knowledge base representation technique includes an acyclic graph.

4. A system for performance monitoring and diagnosis of a target machine, the system comprising:
a management console configured to communicate with an agent deployed on a target machine;
the agent deployed on a target machine configured to gather performance data of the target machine;
the agent deployed on a target machine configured to send the gathered performance data of the target machine to the management console at regular intervals for diagnosis;
a diagnosis engine configured to diagnose the performance data captured at the regular intervals using a knowledge base representation technique; and
the diagnosis engine configured to raise an alert event on the target machine depending on a criticality of the diagnosed performance.

5. The system of claim 4, further comprising a database configure to store the performance data captured at the regular intervals.

6. The system of claim 4, wherein the knowledge base representation technique includes an acyclic graph.

7. A computer storage device tangibly embodying a plurality of instructions on a computer readable medium for performing a method for performance monitoring and diagnosis of a target machine, comprising the steps of:
program code adapted for installing a management console configured to communicate with an agent deployed on a target machine;
program code adapted for gathering performance data of the target machine via the agent deployed on a target machine;
program code adapted for sending via the agent deployed on a target machine the gathered performance data of the target machine to the management console at regular intervals for diagnosis;
program code adapted for diagnosing the performance data captured at the regular intervals using a knowledge base representation technique via a diagnosis engine; and
program code adapted for raising an alert event on the target machine depending on a criticality of the diagnosed performance data via the diagnosis engine.

8. The computer storage device of claim 7, further comprising program code adapted for storing the performance data captured at the regular intervals in a database.

9. The computer storage device of claim 7, wherein the knowledge base representation technique includes an acyclic graph.
